(19) United States
(12) Patent Application Publication
(10) Pub. No.: US 2006/0215483 A1
(43) Pub. Date: Sep. 28, 2006

(54) ASPHALT PAVEMENT RECYCLING METHOD AND COMPOSITIONS

(76) Inventor: Gary Helf, Concord, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/277,420

(22) Filed: Mar. 24, 2006

Related U.S. Application Data
(60) Provisional application No. 60/665,439, filed on Mar. 25, 2005.
(60) Provisional application No. 60/677,154, filed on May 3, 2005.

(51) Int. Cl. B28C 5/46

(52) U.S. Cl. 366/4

(57) ABSTRACT

A method of heating old asphalt grindings for reuse, which is indirect and uses a screw dryer for the process. Granulated old asphalt is mixed with a composition comprising from about 60% to 96% by weight of asphalt, and from about 4% to 40% by weight of a terpenoid liquid.

### RELATED APPLICATIONS

This application claims the benefit of U.S. Provisional Application No. 60/665,439 filed Mar. 25, 2005 and U.S. Provisional Application No. 60/677,154 filed May 3, 2005.

### TECHNICAL FIELD

The present invention generally relates to a method of recycling and heating of old asphalt concrete grindings into new asphalt concrete without the need for any additional aggregate or liquid asphalt and preferably only with the introduction of a liquid composition to complete the process. The invention also relates to the liquid compositions.

### BACKGROUND OF THE INVENTION

Current technology allows the recycling of asphalt concrete pavements wherein old asphalt concrete is ground up and/or crushed and then blended and heated with virgin aggregates and liquid asphalt to produce new asphalt concrete that can be used to form new pavements. The first step in the process involves the processing of existing asphalt concrete pavement by either grinding and removing it from a road surface, or by removal with a loader or excavator and then crushing the material. The material so processed by grinding or crushing is known in the industry as “grindings”. Such ground up or crushed material is also commonly referred to as recycled asphalt pavement (RAP). The physical and chemical makeup of the grindings (aka RAP) is essentially the same as asphalt concrete, i.e. aggregates and asphalt coating the aggregates, except that it has been reduced to particles or granules through grinding or crushing. The grindings may include “chips” that are composed of multiple pieces of aggregate that are glued together by old asphalt. Grindings of a desired size are then blended and heated with virgin aggregates and liquid asphalt to produce new asphalt concrete.

With today's technology, high ratio recycling (more than 35% old asphalt, i.e., grindings) becomes impossible due to problems associated with heating of the grindings to standard hot mix temperatures (280° F. to 300° F.). In the current technology, adding more grindings creates more than 20% opacity in the exhaust stack of the asphalt plant which may exceed limits imposed by governmental bodies. The specific problem is that the old asphalt to be processed, is already coated with bituminous binder. This material creates blue smoke as it is heated in a conventional dryer. The higher the ratio, the more blue smoke, and thus the noncompliance in the degree of opacity.

There is a need to increase the ratio of old asphalt and further to advance technology to arrive at the ultimate, pavement made from 100% recycled asphalt. Arrival at this goal would save money and valuable resources. It is therefore desirable to provide an improved method and material to increase the ratios of recycled to virgin asphalt.

Today's asphalt plants operate to recycle asphalt by means of a conventional rotating dryer. All materials (grindings, virgin aggregate and liquid asphalt) enter the dryer and are heated and blended in this chamber in one operation. Problems occur because all materials must be heated to approximately 300° F. in the short period of time that the material is in the rotary dryer (usually about 5 minutes). The flames that are used to heat the material in this short time can reach 3000° F. Further, the flame is elongated in the dryer so that flames actually touch the grindings. Because the grindings are already coated with bituminous binder, the binder burns and is transformed into smoke and volatile hydrocarbons, high concentrations of which are usually not permitted by governmental standards. The higher the throughput of grindings, the more opacity of the exhaust. With today's technology asphalt needs to be heated to these smoke causing temperatures because the liquid asphalt is too viscous at lower temperatures and therefore will not coat the aggregate. Also, the moisture in the aggregates needs to be driven off as the new liquid binder will not coat the aggregate if it is not dry.

Methods heretofore have been used to recycle 100% ground up asphalt concrete using no virgin aggregate, but these methods do not use heat. One such method adds an emulsified asphalt which is used to coat the grindings. Because emulsified asphalt is liquid at ambient temperatures, it is compatible with the moisture in the aggregate material. But this process has limitations. The problem is that the large amount of water used to make the emulsion workable does not evaporate soon enough, and therefore asphalt recycled in this manner takes up to seven days to cure. Even after curing, this process cannot be used for surface asphalt, as it always remains too soft.

Another method that can be used to recycle 100% old asphalt is by the introduction of solvents, such as kerosene and naphtha, to make the liquid asphalt workable at ambient temperatures. This process also has limitations as once the solvents evaporate, the asphalt concrete remains too soft. Further, this process involves introduction into the air of organic VOC's (volatile organic compounds) which can harm the environment and may not permitted by EPA regulations.

Grindings have also been used in cold mixed asphalt concrete. A cold mix is processed from grindings and coated with liquid products without heat. A problem occurs in this type of process because the grindings or crushed asphalt that is processed may contain chips of asphalt concrete. These chips are multiple pieces of aggregate and old liquid that remained “glued” together and do not break down into their original size. The new liquid does not separate these individual pieces of aggregate. The result is that the cold mix is not a homogenous mix.

### SUMMARY OF THE INVENTION

The present invention solves the problems of higher ratio recycling, as it does not need to heat the aggregates to 300° F. Instead, old recycled asphalt, i.e, grindings, can be recycled at high percentages well above 35% by weight (up to 100%) at temperatures as low as about 160° F. if not lower. The present invention uses a liquid composition that will coat the grindings at these temperatures, and will harden in the asphalt concrete quickly after it reaches ambient temperatures. Therefore, the present invention involves a process of heating without burning together with a liquid composition that coats at lower temperatures and hardens at ambient temperatures. Moreover, there is no need to enclose the heated asphalt and liquid mixture in a sealed chamber.

The present invention may also be used to solve problems of cold mix recycling in that the heat and mechanical action is used to breakdown “chips” of asphalt concrete into their original sizes. The grindings may then be cold mix processed with the result being a more homogeneous mix. More particularly, an indirect heating method uses a hollow screw dryer to heat the grindings to a temperature whereat any chips therein will start to break into smaller or individual aggregate pieces. The mechanical action in the hollow screw dryer separates the chips into the smaller or individual aggregate pieces such that the resultant product is transformed into the originally sized material. This material can then be coated with any cold mix liquid and become a homogeneous mixture for use as a cold mix.

### BRIEF DESCRIPTION OF THE DRAWING

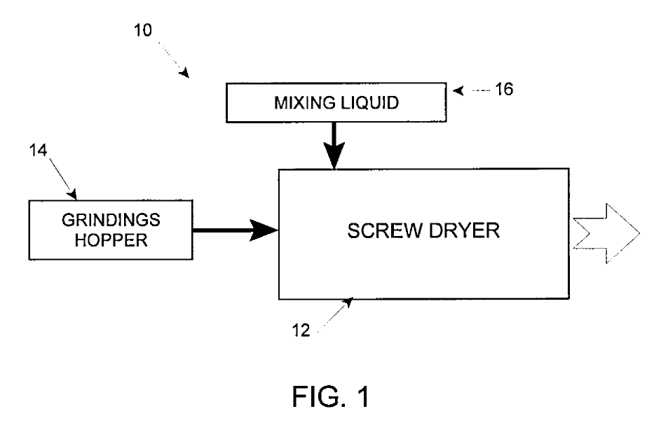

In the annexed drawings, FIG. 1 is a diagrammatic illustration of an exemplary apparatus according to the invention.

### DETAILED DESCRIPTION

The present invention is based on indirect heating rather than direct heating. There is no flame to touch the material and therefore create smoke. According to a preferred embodiment and as depicted in FIG. 1, old asphalt concrete grindings are heated using a screw dryer apparatus 10 which transfers heat through the heated metal screws and/or an outer heated jacket. Screw dryers are manufactured under the names of Thermascrew, Holoflight, Bepex and others. The screw dryer apparatus may have a mixing chamber 12 wherein the mixture is mixed and heated by one or more screw conveyors having hollow flights and/or at least one hollow shaft through which a heat exchange material is passed or which are electrically heated. Previously these heaters were used primarily in the chemical and food business.

The heat transfer medium can be steam or hot oil, or any other medium wherein heat is transferred through the hot metal rather than by flame or hot gases contacting the grindings, Electric heating may be employed if desired.

The screw action advantageously serves to mix the grindings with a liquid composition of the present invention, so that the manufacturing of recycled asphalt concrete is completed at the end to the screw dryer, except for being laid down as pavement. As another advantage, the grindings are heated to a temperature whereat any chips therein will start to break into smaller or individual aggregate pieces. The mechanical action in the hollow screw dryer can separate the heated chips into the smaller or individual aggregate pieces such that the resultant product is transformed into the originally sized material. For a cold mix application, the material can be coated with any cold mix liquid (any of the liquids previously used in asphalt concrete cold mixes) and become a homogeneous mixture for use as a cold mix. For a warm mix application, the material can be coated as discussed in greater detail below.

The screws of the heating and mixing apparatus can be of the twin or single type. The screws can also be built in triple or quadruple. The larger number and size of the screws relates to throughput and production.

Another advantage of the process is that the screw mixer may be relatively small in size and thus fully portable, allowing the screw mixer to be moved to the job site for onsite asphalt reclamation and recycling, thereby eliminating the need to truck asphalt from a central plant. Moreover, the screw mixer does not need to be modified in any way to provide a sealed chamber, such as for control of moisture content. In the practice of the present invention dry grindings may be used.

The sizing or gradation of the grindings may be similar to the original sizing of aggregate used in asphalt concrete pavement. Typical grinding sizes are in the range of 0.25 inch to 1.5 inch. The grindings may be supplied from a hopper 14 or by other suitable means.

The liquid used in the process of recycling preferably coats the ground up asphalt concrete, i.e. grindings, at temperatures as low as 200° F.+5° F., more preferably as low as 180° F. ±5° F., still more preferably as low as 170° F.±5° F., and yet more preferably as low as 160° F.±5° F., if not lower. Conventional liquid asphalt is too viscous at these lower temperatures and particularly at temperatures of about 160° F. or less, and therefore is modified in order to be workable. The liquid material used to soften liquid asphalt according to the present invention preferably contains no water and no solvents that would produce illegal VOC's. The liquid composition of the present invention preferably is biodegradable and therefore does not harm the environment. In a particular embodiment, the mixture may be heated to a temperature of about 210° F. to about 220° F., more generally between about 200° F. to about 240° F., and more generally between about 160° F. and 260° F.

The pavement enhancing compositions according to the present invention preferably contain at least two components. The two components of the asphalt compositions include asphalt and a terpenoid liquid. The liquid may be supplied from a supply 18 thereof.

The pavement enhancing compositions of the present invention contain asphalt. Asphalt generally includes bituminous substances derived from petroleum, shale oil, coal tar, pitches and the like. Asphalt as bitumous substances are typically mixtures of hydrocarbons of natural and/or pyrogenous origin, frequently accompanied by their non-metallic derivatives. Asphalt is a cementitious material having a solid or semi-solid consistency in which the dominating constituents are bituminous which occur in nature as such or are obtained as residua in petroleum refining.

Generally speaking, asphalt is a liquid mixture of paraffinic and aromatic hydrocarbons and heterocyclic compounds containing sulfur, nitrogen and oxygen. Asphalt includes petroleum asphalts, natural asphalts, Gilsonite, air-blown asphalts and other similar type materials. Asphalt may be prepared by vacuum distillation of a topped crude oil. In one embodiment, asphalt has penetration at 25° C. ranging from about 20 to about 300 dmm (as measured by ASTM D5). In a preferred embodiment, asphalt has penetration at 25° C. ranging from about 50 to about 250 dmm, and more preferably from about 75 to about 200 dmm. Asphalts are commercially available. Examples of asphalts include AC-40, AC-20, AC-10, AC-5 and AC-2.5, and soft distillation bottoms such as those manufactured Safety Klean Corp.

In another embodiment, asphalt includes tars and their derivatives, such as coal tars reduced to float grades (RT grades), coal tar pitches, residua from pyrogenous distillates (water-gas, wood, peat, bone, shale, rosin, and fatty acid tars).

In one embodiment, the liquid composition contains from about 20% to about 99% by weight asphalt. In another embodiment, the liquid composition contains from about 30% to about 95% by weight asphalt. In a preferred embodiment, the liquid composition contains from about 40% to about 90% by weight asphalt. In a most preferred embodiment, the liquid composition contains from about 70% to about 96% by weight asphalt.

The liquid compositions of the present invention contain a terpenoid liquid. When asphalt is combined with the terpenoid liquid, the mixture is workable at ambient temperatures. Terpenoid liquids occur in many plants, and thus many may be considered natural products. In one embodiment, the terpenoid liquid is a citrous product (derived from plants bearing citrous fruits).

Terpenoids are generally derivatives of isoprene (a C₅ unit). Terpenoids include terpenes and compounds of terpene origin that do not have carbon skeletons composed exclusively of isoprene units. Compounds of terpene origin that do not have carbon skeletons composed exclusively of isoprene units are termed terpene derivatives. Terpenoids include cyclic terpenoids (open chain) and cyclic terpenoids such as monocyclic terpenoids, bicyclic terpenoids, tricyclic terpenoids, etc. Terpenoids may include a racemic mixture of enantiomeric terpenoids or a substantially pure optically active isomer of a terpenoid.

In one embodiment, the terpenoid is a terpene (having a carbon skeleton composed exclusively of isoprene units). In another embodiment, the terpenoid is a terpene derivative that does not have a carbon skeleton composed exclusively of isoprene units. Terpene derivatives typically have a terpene skeleton which is altered through at least one of rearrangements, degradative loss of carbon atoms, oxygenated derivatives, hydrogenated derivatives and possessing additional carbon atoms of nonterpene origin. Terpenes include hemiterpenes, monoterpenes, sesquiterpenes, diterpenes, sesterterpenes, and triterenes. Terpene derivatives include the saturated and partially saturated isomers of terpenes, derivatives of terpenes, in addition to the alcohols, aldehydes, esters of terpenes, etc.

Specific examples of terpenoids include tricyclene, α-pinene, α-fenchene, camphine, β-pinene, myrcene, cis-pinane, cis-p-menthane, 1,4-cineole, 1,8-cineole, liminonene, p-cynene, fenchone, α-terpinene, β-terpinene, γ-terpenene, linalool, coridandrol, α-fenchol, citronellal, camphor, trans-β-terpineol, trans-menthone, terpinen-4-ol, neomenthol, borneol, isoborneol, menthol, citronellol, nerol, geraniol, carvon, hydroxycitronellal, terpin, α-ionone, β-inonone, 3-carene, alloocimene, myrcenol, geraniol, farnesol, geranylgaraniol, squalene, the substantially pure D or L optical isomers thereof, positional isomers thereof, derivatives and other isomers thereof, and combinations of two or more thereof. By way of example, optical isomers include D-limonene and L-limonene; linalool and coridandrol (the L and D-isomers of 3,7-dimethyl-1,6-octadiene-3-ol, respectively), and the o- and p-positional isomers of cymene (isopropyl toluene) include o-cymene, m-cymene and p-cymene.

Terpenoid liquids may be obtained from plants, plant extracts, by synthetically manipulating plants or plant extracts, and/or by synthetical techniques known to those skilled in the art. Terpenoid liquids are commercially available. The so-called acetylene-acetone synthetic route can be used to synthesize monoterpenes. Synthetic manipulations include steps such as hydrogenation, oxidation, reduction, alkylation, dealkylation, rearrangements and other procedures commonly used in synthetic organic chemistry.

Terpenoid liquids specifically include oils derived from plants, which are biodegradable, and specifically modified vegetable oils, such as modified soybean oil (methyl esters of soybean oil) available under the trade designation Soygold (Soygold 1000 and 2000) from A.G. Environmental Products, other bean derived oils, conola oil, corn oil, sunflower oil, etc, which may or may not be modified. Another specific example of a plant derived terpenoid liquid is available under the trade designation SBO from Young Chemical Company of Brookpark, Ohio.

The liquid of the present invention serves two purposes. First, is coats the asphalt concrete pavement grindings at lower temperatures and additionally rejuvenates the old liquid binder that is in the grindings. Over time, newly produced asphalt concrete becomes brittle, as oxidation hardens the liquid binder, and thus the asphalt concrete becomes more brittle and then is subject to cracking. When asphalt concrete is manufactured, it has a penetration of from about 60 to 90. As the asphalt ages (oxidizes) the penetration reduces making the asphalt brittle and thus susceptible to cracking. In addition to coating at lower temperatures, the present invention also increases the penetration of the old liquid binder and thus increases the life of the material being processed.

While the invention has been explained in relation to its preferred embodiments, it is to be understood that various modifications thereof will become apparent to those skilled in the art upon reading this specification.

What is claimed is:

1. A method of heating asphalt concrete grindings for reuse, wherein the grindings are indirectly heated using a screw dryer and mixed with asphalt and terpenoid liquid to form an asphalt concrete mixture.

2. A method as set forth in claim 1, wherein the grindings are mixed with a composition comprising from about 60% to 96% by weight of asphalt, and from about 4% to 40% by weight of a terpenoid liquid.

3. A method as set forth in claim 1, wherein essentially 50% of the aggregate content of the asphalt concrete mixture is derived from the grindings.

4. A method as set forth in claim 1, wherein essentially 60% of the aggregate content of the asphalt concrete mixture is derived from the grindings.

5. A method as set forth in claim 1, wherein essentially 70% of the aggregate content of the asphalt concrete mixture is derived from the grindings.

6. A method as set forth in claim 1, wherein essentially 80% of the aggregate content of the asphalt concrete mixture is derived from the grindings.

7. A method as set forth in claim 1, wherein essentially 90% of the aggregate content of the asphalt concrete mixture is derived from the grindings.

8. A method as set forth in claim 1, wherein essentially 100% of the aggregate content of the asphalt concrete mixture is derived from the grindings.

9. A method as set forth in claim 1, when used to produce a reusable asphalt concrete without the introduction of any significant quantity of virgin asphalt material.

10. A method as set forth in claim 1, wherein the terpenoid liquid comprises a terpene.

11. A method as set forth in claim 1, wherein the terpenoid liquid comprises limonene.

12. A composition comprising from about 60% to 96% by weight of asphalt concrete grindings, and from about 4% to 40% by weight of a terpenoid liquid.

13. A composition as set forth in claim 12, wherein the terpenoid liquid comprises a terpene.

14. A composition as set forth in claim 12, wherein the terpenoid liquid comprises limonene.

15. A composition as set forth in claim 12, wherein the terpenoid liquid comprises D-Limonene.

16. A method of processing asphalt concrete grindings for reuse, wherein the grindings are indirectly heated and agitated using a screw dryer to break up any glued together pieces of aggregate.

17. A method as set forth in claim 16, wherein the grindings are mixed with a cold mix liquid composition, and comprising the further step of using the mixture as a cold mix.

18. A method as set forth in claim 17, wherein essentially 100% of the aggregate content of the cold mix is derived from the grindings.
